(19) United States
(12) Patent Application Publication
(10) Pub. No.: US 2009/0059444 A1
(43) Pub. Date: Mar. 5, 2009

(54) METHODS AND STRUCTURES FOR AN INTEGRATED TWO-AXIS MAGNETIC FIELD SENSOR

(75) Inventors: Phillip Glenn Mather, Maricopa, AZ (US); Jijun Sun, Chandler, AZ (US); Young Sir Chung, Chandler, AZ (US)

Correspondence Address: INGRASSIA FISHER & LORENZ, P.C. (FS), 7010 E. COCHISE ROAD, SCOTTSDALE, AZ, 85253, US

(73) Assignee: FREESCALE SEMICONDUCTOR, INC., Austin, TX (US)

(21) Appl. No.: 11/848,053

(22) Filed: Aug. 30, 2007

(51) Int. Cl. G11B 5/33

(52) U.S. Cl. 360/324.11

(57) ABSTRACT

A two-axis, single-chip external magnetic field sensor incorporates tunneling magneto-resistance (TMR) technology. In one embodiment, an integrated device includes at least two sensor elements having pinned layers with orientation situated at a known angle (e.g., 90 degrees) with respect to each other. In the presence of a magnetic field, the information from the multiple sensor elements can be processed (e.g., using a conventional bridge configuration) to determine the orientation of the integrated sensor with respect to the external field. In order to achieve an integrated sensor with multiple pinned layer orientations, a novel processing method utilizes antiferromagnetic pinning layers different materials with different blocking temperatures (e.g., PtMn and IrMn).

### TECHNICAL FIELD

The present invention generally relates to magnetic field sensors, and more particularly relates to magnetic field sensors incorporating magnetoresistive devices.

### BACKGROUND

It is often desirable to electronically sense the direction of an external magnetic field—for example, in various electronic compass applications and the like—using compact electronic components. Such devices are desirable in GPS systems, which do not provide orientation information while standing still, and may also be used in cellular phone applications to track location and movement when GPS communication is interrupted. In these applications, the electronic compass can provide information that allows location to be calculated through “dead reckoning”—i.e., calculation of position based on a known position and incremental movements in a known direction.

A variety of magnetic field sensors are known in the art. For example, various field sensors have been developed utilizing magnetoresistance technology, incorporating magnetic tunneling junction (MTJ) structures. Conventional low-field field sensors of this type are generally anisotropic magnetoresistance (AMR) based devices. In order to achieve the desired sensitivity and reasonable resistances that work well with conventional CMOS devices, however, the sensing units of such sensors are generally on the order of one or more square millimeters in size. Furthermore, large reset pulses (e.g., approximately 10 mA) from bulky coils are typically required in these applications.

It is therefore desirable to provide improved magnetic field sensors that are low-cost, low-power, compact, and easily integrated with conventional semiconductor technologies. Other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a conceptual cross-sectional view of a typical magnetoresistive stack in accordance with one embodiment;

FIG. 2 shows a conceptual top view and isometric view of an integrated chip with two sensors in accordance with one embodiment; and

FIGS. 3, 4, and 5 are conceptual top views and corresponding isometric views illustrating a method of manufacturing a sensor in accordance with one embodiment.

### DETAILED DESCRIPTION

The various embodiments described herein relate to an improved two-axis, single-chip external magnetic field sensor that incorporates tunneling magneto-resistance (TMR) technology. In one embodiment, an integrated device includes at least two sensor elements having pinned layers with orientation situated at a known angle (e.g., 90 degrees) with respect to each other. In the presence of a magnetic field, the information from the multiple sensor elements can be processed (e.g., using a conventional bridge configuration) to determine the orientation of the integrated sensor with respect to the external field. By using TMR-based technology, the resulting sensor is compact, low power, and low cost. In order to achieve an integrated sensor with multiple pinned layer orientations, a novel processing method utilizes antiferromagnetic pinning layers different materials with different blocking temperatures (e.g., PtMn and IrMn).

The following detailed description is merely exemplary in nature and is not intended to limit the range of possible embodiments and applications. Furthermore, there is no intention to be bound by any theory presented in the preceding background or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein. Unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

The terms “comprise,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.”

In the interest of conciseness, conventional techniques, structures, and principles known by those skilled in the art may not be described herein, including, for example, standard MTJ processing techniques, fundamental principles of magnetism, and basic operational principles of field sensors. For the purposes of clarity, some commonly-used layers may not be illustrated in the drawings, including various protective cap layers, seed layers, and the underlying substrate (which may be a conventional semiconductor substrate or any other suitable structure).

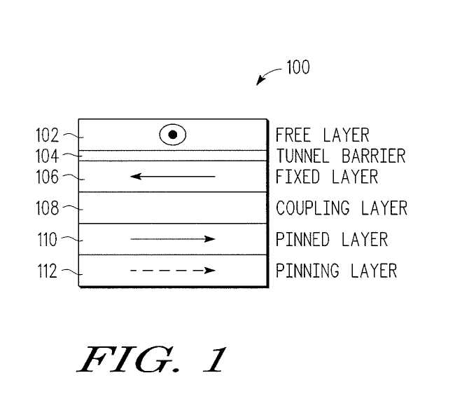

Referring to FIG. 1, a suitable MTJ structure 100 for use as a sensor element includes a free layer 102, a fixed layer 106, and a tunnel barrier 104 situated therebetween. A ferromagnetic pinned layer 110 is coupled to a pinning layer 112 (having a predetermined coupling direction as denoted by the dashed arrow in FIG. 1), and is separated from fixed layer 106 by a coupling layer 108. Pinned layer 110 and fixed layer 106 have fixed magnetic orientations with respect to external field—as indicated by the linear arrows in FIG. 1—through their magnetic coupling to pinning layer 112. Layer 102 may be a synthetic antiferromagnet (SAF), or a single soft ferromagnetic layer, such as Fe, NiFe or CoFeB, or a combination thereof. Alternatively, fixed layer 106 and coupling layer 108 may be removed such that the magnetic stack consists of pinning layer 112, pinned layer 110, tunnel barrier 104, free layer 102, and various capping layers.

Free layer 102 has a magnetic orientation (out of the page, in this figure) that is responsive to an external magnetic field, and thus is free to change orientation. As is known in the art, the resistance value of structure 100 is a function of the differences in orientations between free layer 102 and fixed layer 106 (or pinned layer 110 if fixed and coupling layers are removed). The conductance through structure 100 follows the relation G=G₀(1+P² cos(α)), where G₀ is the average of high and low state conductance, P is the polarization of the electrons traversing the structure, and α is the angle formed between the magnetizations of the ferromagnetic layers on either side of the tunnel barrier. Thus, by incorporating two such structures having different pinned orientations, after accounting for the angular response of the individual sense layers, the direction of the external magnetic field may be uniquely determined.

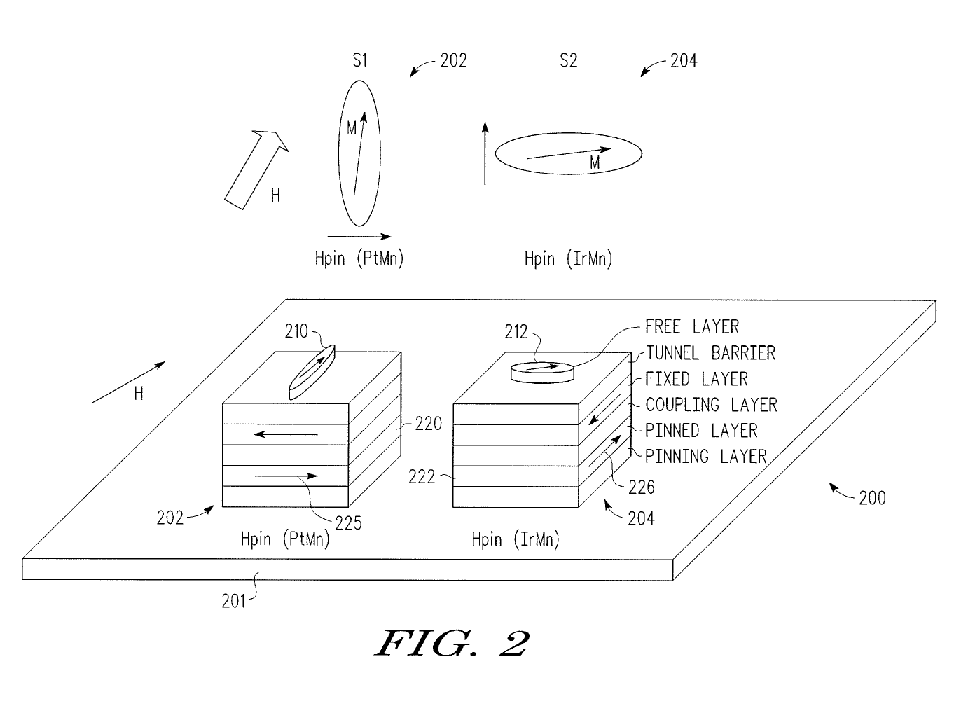

More particularly, referring to the conceptual top and isometric views shown in FIG. 2, a magnetic field sensing device 200 includes a magnetoresistive sensor element (S1) 202 and a magnetoresistive sensor element (S2) 204, both formed on a suitable substrate 201. Sensor element 202 is an MTJ structure comprising a first free layer 210 and a first pinned layer 220 having a first orientation 225. Similarly, magnetoresistive sensor element 204 includes a free layer 212 and a pinned layer 222 having a second orientation 226. The first and second free ferromagnetic layers 210 and 212 are responsive to an external magnetic field such that the first and second magnetoresistive sensor elements 202 and 204 exhibit respective first and second resistance values correlatable through their magnetic anisotropies to the orientation of an external magnetic field.

In accordance with one aspect, orientation 225 is not equal to orientation 226. The difference in orientation may be selected in accordance with applicable design goals. In a particular embodiment, however, orientation 225 is perpendicular to or orthogonal to orientation 226.

In order to fabricate a multi-element sensing device having different pinned layer orientations, it is desirable for first pinning layer to comprise a first material having a first blocking temperature, while the second pinning layer comprises a second material having a second blocking temperature that is not equal to the first blocking temperature. In a particular embodiment, for example, the first material is PtMn (which once crystallized through a setting anneal in a particular coupling direction has a blocking temperature greater than 350° C.), and the second material is IrMn (which has a blocking temperature of 200-250° C.).

In accordance with one method of making such a device, the pinning direction of the first pinning layer adjacent the first pinned layer 220 and a second pinning layer adjacent the second pinned layer 222 are set at different temperatures during successive annealing steps that make use of the difference in blocking temperatures. That is, one pinned layer is set at a temperature that is greater than the blocking temperature of the second pinning layer in the presence of an applied field having a first orientation. Subsequently, the magnetization of the second pinned layer is set at a second temperature that is greater than the second blocking temperature but less than the first blocking temperature, wherein the applied field is changed before the second anneal such that it has an orientation orthogonal to the first orientation.

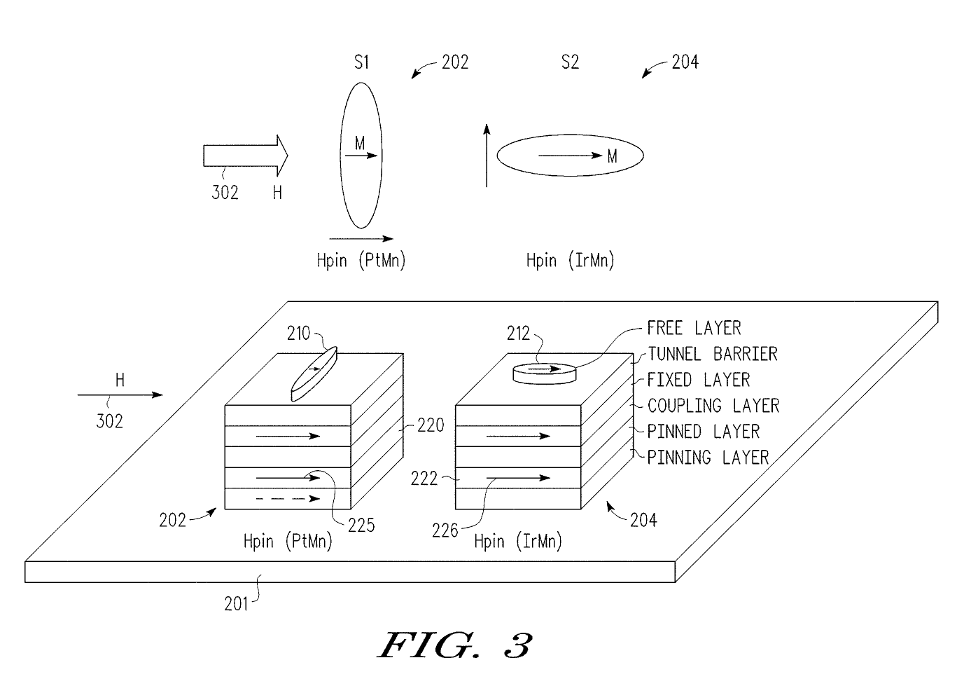

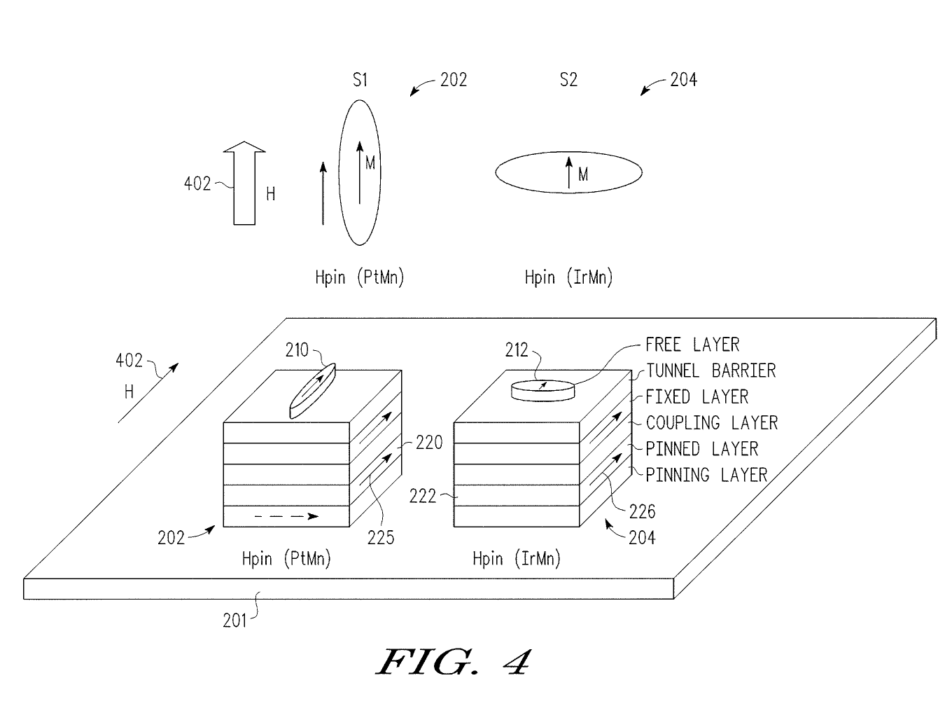

This process is generally illustrated in FIGS. 3 and 4, wherein exemplary materials PtMn and IrMn are used for the pinning layers. In FIG. 3, a field 302 is applied (e.g., approximately 1 Tesla) at a temperature above about 300° C. for about two hours. The device is then cooled to room temperature. Under these conditions, both pinning layers are set with a coupling direction indicated by the dashed arrows, and pinned layers 220 and 222 are oriented parallel to field 302.

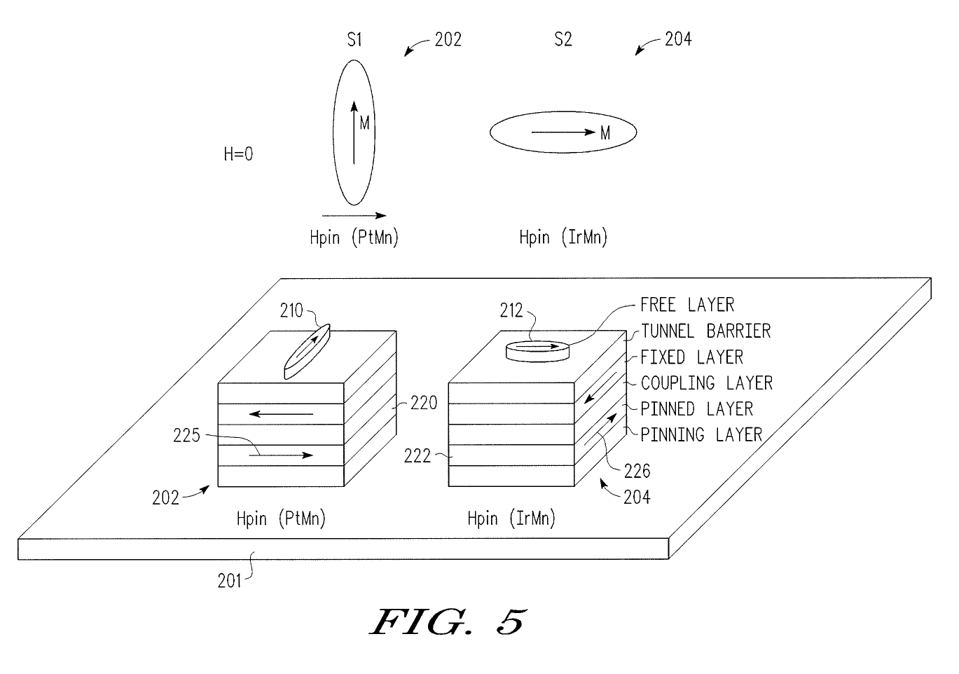

Next, the applied field is rotated (or the device is rotated) such that the applied field 402 is now orthogonal to the first applied field 302, and the device is raised to about 250° C. (FIG. 4), which is above blocking temperature of IrMn pining layer, for a predetermined length of time (e.g., about 0.5 to 2 hours). This effectively “resets” the pinned direction 226 of the pinned layer 222, which changes pinned direction to match that of field 402. When the device is then cooled and the applied field is removed, the pinned layer 220 remains pinned in direction 225 (aligned with external field 302) and the pinned layer 222 remains pinned in direction 226 (aligned with external field of 402), so that pinned layers 220 and 222 will exhibit orthogonal orientations, as illustrated in FIG. 5.

After fabrication, the magnetization of the first and second free layers 210 and 212 may reorient due to the presence of an external field (e.g., the earth's magnetic field) as illustrated in FIG. 2. Suitable bridge and/or control circuitry may be used to convert the resistance values of elements 202 and 204 to the actual orientation of the external magnetic field. In one embodiment, standard CMOS logic is integrated into the same substrate 201 on which the elements 202 and 204 are formed.

In another embodiment, the pinning layers, pinned layer, and optionally the coupling and fixed layers may be deposited on top of the tunnel barrier layer, and the sense layer below. This embodiment allows the pinned layers to be lithographically patterned to a smaller dimension than the sense layer, and decouples the active area of the tunnel junction structure. This eliminates contribution to the device signal from the ends of the free layer which may have a less well-determined magnetic orientation due to their micromagnetic state. Additionally the device resistance may be determined independently from the combination of the resistance area product (RA) of the tunnel barrier layer and the area of the sense layer.

In summary, what has been described is a magnetic field sensing device comprising: a first magnetoresistive sensor element comprising a first free layer, a tunnel barrier layer, a first pinned layer having a first orientation, and a first pinning layer; and a second magnetoresistive sensor element comprising a second free layer, a second tunnel barrier layer, a second pinned layer having a second orientation, and a second pinning layer; wherein the first orientation is not equal to or opposite of the second orientation, and wherein the first and second free layers are responsive to an external magnetic field such that the first and second magnetoresistive sensor elements exhibit respective first and second resistance values correlatable to the orientation of the external magnetic field. In one embodiment, the first orientation is orthogonal to the second orientation. In another embodiment, the first and second magnetoresistive sensors elements are incorporated into a common semiconductor substrate. In a further embodiment, the first pinning layer comprises a first material having a first blocking temperature, and the second pinning layer comprises a second material having a second blocking temperature that is not equal to the first blocking temperature. The first blocking temperature may be approximately 50 C greater than the second blocking temperature. In one embodiment, the second material is one of IrMn, RhRuMn, and RhMn, and the first material is PtMn. The first magnetoresistive sensor element may further include a fixed layer and a coupling layer between the first tunnel barrier layer and the first pinned layer. The second magnetoresistive sensor element may further include a fixed layer and a coupling layer between the second tunnel barrier layer and the second pinned layer

A method of making a magnetic field sensing device includes the step of: forming a first magnetoresistive sensor element having a first free layer, a first tunnel barrier layer, a first pinned layer having a first orientation, and a first pinning layer; and forming a second magnetoresistive sensor element having a second free layer, a second tunnel barrier layer, a second pinned layer having a second orientation, and a second pinning layer, such that the first orientation is not equal to or opposite of the second orientation, and wherein the first and second free layers are responsive to an external magnetic field such that the first and second magnetoresistive sensor elements exhibit respective first and second resistance values correlatable to the orientation of the external magnetic field. In one embodiment, the first orientation is orthogonal to the second orientation. The method may further include the step of forming the first and second magnetoresistive sensors elements on a common semiconductor substrate.

In one embodiment, a first pinning layer adjacent the first pinned layer is formed from a first material having a first blocking temperature, and a second pinning layer adjacent the second pinned layer is formed from a second material having a second blocking temperature that is not equal to the first blocking temperature. The first pinned layer may be set at a first temperature that is either greater than a recrystallization temperature of the first pinning layer or greater than both the first and second blocking temperatures in the presence of an applied field having a first orientation, and wherein the second pinned layer is subsequently set at a second temperature that is greater than the second blocking temperature but less than the first blocking temperature in the presence of an applied field having a second orientation orthogonal to the first orientation. The first blocking temperature may be at least 50 C greater than the second blocking temperature. The first material may be PtMn, while the second material is one of the alloys IrMn, RhRuMn, or RhMn.

In one embodiment, forming the first magnetoresistive sensor element further includes forming a fixed layer and a coupling layer between the first tunnel barrier layer and the first pinned layer. Forming the second magnetoresistive sensor element further includes forming a fixed layer and a coupling layer between the second tunnel barrier layer and the second pinned layer.

A method of sensing an external magnetic field generally comprising the steps of: providing a first magnetoresistive sensor element comprising a first free layer, first tunnel barrier layer, a first pinned layer having a first orientation, and a first pinning layer; and providing a second magnetoresistive sensor element comprising a second free layer, second tunnel barrier layer, a second pinned layer having a second orientation, and a second pinning layer, wherein the first orientation is not equal to or opposite of the second orientation, and wherein the first and second free layers are responsive to an external magnetic field such that the first and second magnetoresistive sensor elements exhibit respective first and second resistance values; and determining the orientation of the external magnetic field based on the first and second resistance values. In one embodiment, the first orientation is orthogonal to the second orientation, and the first and second magnetoresistive sensors elements are incorporated into a common semiconductor substrate. In another embodiment, the first pinning layer comprises a first material having a first blocking temperature, and the second pinning layer comprises a second material having a second blocking temperature that is not equal to the first blocking temperature.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims.

1. A magnetic field sensing device comprising:
a first magnetoresistive sensor element comprising a first free layer, a tunnel barrier layer, a first pinned layer having a first orientation, and a first pinning layer; and
a second magnetoresistive sensor element comprising a second free layer, a second tunnel barrier layer, a second pinned layer having a second orientation, and a second pinning layer;
wherein the first orientation is not equal to or opposite of the second orientation, and wherein the first and second free layers are responsive to an external magnetic field such that the first and second magnetoresistive sensor elements exhibit respective first and second resistance values correlatable to the orientation of the external magnetic field.

2. The sensing device of claim 1, wherein the first orientation is orthogonal to the second orientation.

3. The sensing device of claim 1, wherein the first and second magnetoresistive sensors elements are incorporated into a common semiconductor substrate.

4. The sensing device of claim 3, wherein the first pinning layer comprises a first material having a first blocking temperature, and the second pinning layer comprises a second material having a second blocking temperature that is not equal to the first blocking temperature.

5. The sensing device of claim 4, wherein the first blocking temperature is approximately 50 C greater than the second blocking temperature.

6. The sensing device of claim 5, wherein the second material is selected from the group consisting of IrMn, RhRuMn, and RhMn, and the first material is PtMn.

7. The sensing device of claim 1, wherein the first magnetoresistive sensor element further includes a fixed layer and a coupling layer between the first tunnel barrier layer and the first pinned layer.

8. The sensing device of claim 1, wherein the second magnetoresistive sensor element further includes a fixed layer and a coupling layer between the second tunnel barrier layer and the second pinned layer

9. A method of making a magnetic field sensing device, comprising:
forming a first magnetoresistive sensor element having a first free layer, a first tunnel barrier layer, a first pinned layer having a first orientation, and a first pinning layer; and
forming a second magnetoresistive sensor element having a second free layer, a second tunnel barrier layer, a second pinned layer having a second orientation, and a second pinning layer, such that the first orientation is not equal to or opposite of the second orientation, and wherein the first and second free layers are responsive to an external magnetic field such that the first and second magnetoresistive sensor elements exhibit respective first and second resistance values correlatable to the orientation of the external magnetic field.

10. The method of claim 9, wherein the first orientation is orthogonal to the second orientation.

11. The method of claim 9, further including the step of forming the first and second magnetoresistive sensors elements on a common semiconductor substrate.

12. The method of claim 11, wherein a first pinning layer adjacent the first pinned layer is formed from a first material having a first blocking temperature, and a second pinning layer adjacent the second pinned layer is formed from a second material having a second blocking temperature that is not equal to the first blocking temperature.

13. The method of claim 12, wherein the first pinned layer is set at a first temperature that is either greater than a recrystallization temperature of the first pinning layer or greater than both the first and second blocking temperatures in the presence of an applied field having a first orientation, and wherein the second pinned layer is subsequently set at a second temperature that is greater than the second blocking temperature but less than the first blocking temperature in the presence of an applied field having a second orientation orthogonal to the first orientation.

14. The method of claim 13, wherein the first blocking temperature is at least 50 C greater than the second blocking temperature.

15. The method of claim 14, wherein the first material is PtMn, and the second material is selected from the group consisting of IrMn, RhRuMn, and RhMn.

16. The method of claim 9, wherein forming the first magnetoresistive sensor element further includes forming a fixed layer and a coupling layer between the first tunnel barrier layer and the first pinned layer.

17. The method of claim 9, wherein forming the second magnetoresistive sensor element further includes forming a fixed layer and a coupling layer between the second tunnel barrier layer and the second pinned layer.

18. A method of sensing an external magnetic field, comprising the steps of:
providing a first magnetoresistive sensor element comprising a first free layer, first tunnel barrier layer, a first pinned layer having a first orientation, and a first pinning layer; and
providing a second magnetoresistive sensor element comprising a second free layer, second tunnel barrier layer, a second pinned layer having a second orientation, and a second pinning layer, wherein the first orientation is not equal to or opposite of the second orientation, and wherein the first and second free layers are responsive to an external magnetic field such that the first and second magnetoresistive sensor elements exhibit respective first and second resistance values; and
determining the orientation of the external magnetic field based on the first and second resistance values.

19. The method of claim 18, wherein the first orientation is orthogonal to the second orientation, and the first and second magnetoresistive sensors elements are incorporated into a common semiconductor substrate.

20. The method of claim 18, wherein the first pinning layer comprises a first material having a first blocking temperature, and the second pinning layer comprises a second material having a second blocking temperature that is not equal to the first blocking temperature.
